(19) United States
(12) Patent Application Publication
(10) Pub. No.: US 2017/0269667 A1
(43) Pub. Date: Sep. 21, 2017

(54) ELECTRONIC DEVICE AND ENERGY SAVING METHOD

(71) Applicants: National Taiwan University, Taipei (TW); Media Tek Inc., Hsinchu (TW)

(72) Inventors: Wei-Ming Chen, Taipei (TW); Sheng-Wei Cheng, Taipei (TW); Han-Yi Lin, Taipei (TW); Pi-Cheng Hsiu, Taipei (TW); Tei-Wei Kuo, Taipei (TW)

(21) Appl. No.: 15/233,226

(22) Filed: Aug. 10, 2016

(30) Foreign Application Priority Data
Mar. 18, 2016 (TW) 105108597

(51) Int. Cl. G06F 1/32; G06F 9/50; G06T 1/20

(52) U.S. Cl. CPC G06F 1/324; G06F 1/3228; G06T 1/20; G06F 9/5094; G06T 2200/28

(57) ABSTRACT

An electronic device comprises a central processing unit, a central processing unit governor, a graphics processing unit, a graphics processing unit governor and a governing framework. The governing framework comprises a user demand classifier, a unified policy selector, and a frequency-scaling intent communicator. An electronic device energy saving method is provided to bridge the processor-level gap and demand-level gap in order to reduce energy consumption of graphics-intensive applications.

### CROSS-REFERENCE TO RELATED APPLICATION

This application claims priority of application No. 105108597, filed on Mar. 18, 2016 in the Taiwan Intellectual Property Office.

### FIELD OF THE INVENTION

The invention relates to an electronic device and an energy saving method thereof, which is designed to bridge both processor-level gap and demand-level gap in order to reduce energy consumption of graphics-intensive applications.

### BACKGROUND OF THE INVENTION

Since the introduction of Graphics Processing Units (GPUs), efficient graphics rendering is accomplished by the cooperation of Central Processing Units (CPUs) and GPUs in a system. For example, a typical 3D gaming workload contains at least two distinct phases, which consist of a loading phase and a frame rendering phase. In the loading phase, the CPU is busy constructing the graphics data by using complex game physics for 3D scenes and configuring the GPU for initialization (e.g. object loading, 3D scene configuring, etc.). In turn, in the frame rendering phase, the GPU is busy rendering the frames according to the data delivered from the CPU in a best-effort fashion.

To perform the two phases, an application will generate a series of GPU commands with the help of libraries, compilers, and runtime frameworks. The device driver for a GPU device contains a command buffer and a command dispatch unit. In order to transfer GPU commands from the CPU to the GPU, an application first pushes GPU commands into the command buffer. Accordingly, the GPU driver notifies the GPU device of the commands by configuring the command dispatch unit. In this way, workloads can successfully be dispatched onto the GPU device.

To adapt to different Performance/Energy tradeoffs that a user desires, different policies for scaling the available frequencies of a processor have been proposed for an energy governor. Specifically, an energy governor allocates computing resource of a processor such as a CPU or a GPU based on some policy rules.

Typically, in order to exploit the best performance of a processor, the Performance policy will set the processor to the highest available frequency. Whereas, to reduce the energy consumption as much as possible, the Power-saving policy will set the processor to the lowest available frequency. Furthermore, in view of the cases in between, the On-demand and Conservative policies are designed to adapt to different workloads on the fly. Both the On-demand policy and the Conservative policy set a lower and an upper utilization threshold. When the lower utilization threshold is reached, both the policies will scale down the processor to, if any, the next available lower frequency.

However, the two policies behave differently when the higher utilization threshold is reached. That is, the On-demand policy will scale up the processor to the highest available frequency, while the Conservative policy will scale up the processor to, if any, the next available higher frequency. Given these policies, a user can enforce a policy according to the user's desired Performance/Energy tradeoff for governing the CPU or GPU, respectively. However, since the workloads on both the CPU and the GPU can be revealed by GPU commands, a better policy can be obtained if the energy consumption of both CPUs and GPUs can be jointly governed.

Consider, if the execution phases of the application are known and the ability to jointly configure the adopted governor policies for the CPU and GPU is allowed. Specifically, when the application is in the loading phase, the governing policies for the CPU and the GPU are configured to be Conservative and Power-saving, respectively. Moreover, when the application is in the frame rendering phase, the governing policies for both the CPU and the GPU are configured to be Power-saving.

Along with the introduction of DVFS (Dynamic Voltage and Frequency Scaling) enabled CPUs, significant research has been devoted to both the theory and practice of energy-efficient scheduling. In theory, given that the real-time constraints of applications are known, an off-line optimal scheduling algorithm is provided.

However, in practice, it is frequently difficult to determine the exact execution characteristics of an application in advance. Commodity operating systems introduce, apart from a workload scheduler, a governor that monitors CPU loading during a scheduling period and adjusts the processors frequency accordingly.

When different performance/energy tradeoffs are considered, governor policies have been proposed with different frequency-scaling criteria. Investigations into governing DVFS-enabled CPUs have led to successful energy reduction thereby driving the proliferation of new DVFS-enabled processors and devices. With the emergence of DVFS-enabled GPUs in the latest mobile devices, executing graphics-intensive game applications efficiently in terms of energy has become possible.

With the introduction of GPUs, efficient graphics rendering is now accomplished through the cooperation of the CPU and the GPU in a system. For example, a typical 3D gaming workload contains at least two distinct phases: a loading phase and a frame rendering phase. Existing research only targets power management strategies in the frame rendering phase. Also, it aims to achieve the target FPS (Frames per Second) range while minimizing power consumption. However, this method focuses only on the rendering phase of a gaming application, and therefore, applications with frequent phase changing are left out. This may result in a governing strategy that has a detrimental impact on the user experience, because a user cares about different performance metrics at different phases of a gaming application (a demand-level gap).

Previous research into optimizing the energy efficiency of game applications has considered the perspectives of user interaction and workload prediction. For game applications without involving much user interaction, the scene of the workloads depends heavily on game frames which offer a rich variety of structural information. Owing to the structural information, gaming workload characteristics can be derived by parsing the game frames, such as the texture operations, or the number of brush and alias models.

In this way, frequency scaling strategies for either a CPU or GPU have been proposed. On the other hand, things become more complicated when intensive user interaction is considered. This is because buffering frames in game applications is hardly possible due to its dependence on the user input. In view of this, algorithms aiming at the prediction accuracy were proposed for CPU frequency scaling, which are to periodically adjust the workload prediction based on the feedback of the prediction errors. The work, which considers to jointly govern CPUs and GPUs, aims to achieve the target FPS range while minimizing power consumption in a reactive fashion.

Previous research into optimizing the energy efficiency of graphics-intensive applications has considered the perspectives of user interaction and workload prediction. These approaches only consider the governance of a CPU or a GPU in isolation. However, graphics-intensive game applications place high demands on both the CPU and GPU. Therefore, managing these processors in isolation may result in an information gap between their respective governors (a processor-level gap) and may thus result in inefficient energy use. However, the present invention is designed to bridge the processor-level gap and demand-level gap in order to reduce energy consumption of graphics-intensive applications.

Therefore, it is important for related equipment manufacturers and researchers to devise an electronic device and an energy saving method thereof without aforesaid drawbacks of the prior art.

### SUMMARY OF THE INVENTION

In order to achieve the above and other objectives, the present invention provides an electronic device for operating an application program. The application program produces at least one graphics processing unit command and the electronic device comprises: a central processing unit; a central processing unit governor connected to the central processing unit; a graphics processing unit; a graphics processing unit governor connected to the graphics processing unit; and a governing framework that comprises: a user demand classifier connected to the application program, which profiles at least one graphics processing unit command that is produced by the application program and classifies the application program into at least one application program phase according to the graphics processing unit command; a unified policy selector connected to the user demand classifier, the central processing unit governor, and the graphics processing unit governor, which determines a governing policy for the central processing unit governor and a governing policy for the graphics processing unit governor according to the application program phase; and a frequency-scaling intent communicator that comprises: a processor-status detector connected to the central processing unit governor and the graphics processing unit governor, which detects a usage pattern of the central processing unit and a usage pattern of the graphics processing unit; and a frequency-scaling intent interpreter connected to the processor-status detector, the central processing unit governor, and the graphics processing unit governor, which classifies a frequency-scaling intent of the central processing unit and a frequency-scaling intent of the graphics processing unit according to the usage pattern of the central processing unit and the usage pattern of the graphics processing unit; wherein the central processing unit governor and the graphics processing unit governor determine a management policy of the central processing unit and a management policy of the graphics processing unit according to the governing policy and the frequency-scaling intent of the central processing unit and the governing policy and the frequency-scaling intent of the graphics processing unit.

A preferred embodiment of the present invention further comprises a command queue and the command queue receives at least one graphics processing unit command.

In a preferred embodiment of the present invention, the central processing unit governor allocates computing resource of the central processing unit based on the operating frequency of the central processing unit, number of active central processing unit cores, and a combination of the active central processing unit clusters.

In a preferred embodiment of the present invention, the graphics processing unit governor allocates computing resource of the graphics processing unit based on the operating frequency of the graphics processing unit and the number of active graphics processing unit cores.

In a preferred embodiment of the present invention, the frequency-scaling intent comprises speedup, slowdown and self-rule, and the application program phase comprises a graphics processing unit sensitive phase and a graphics processing unit insensitive phase.

In a preferred embodiment of the present invention, in the last period of the application program, if the graphics processing unit command emphasizing the central processing unit computing or no commands at all are observed, the application program phase is determined to be the graphics processing unit insensitive phase. In the last period of the application program, if the application program phase is not the graphics processing unit insensitive phase, the application program phase is determined to be the graphics processing unit sensitive phase.

A preferred embodiment of the present invention further comprises if there is any touch event, the state of user attention is determined to be the interacting phase, if it is not an interacting phase, the state of user attention is determined to be the non-interacting phase, and the central processing unit governor and the graphics processing unit governor determine the management policy of the central processing unit and the management policy of the graphics processing unit according to the user attention, the governing policy, and the frequency-scaling intent of the central processing unit and the user attention, the governing policy, and the frequency-scaling intent of the graphics processing unit.

The present invention provides an energy saving method for operating an application program, and the application program produces at least one graphics processing unit command. The energy saving method comprises the steps: profiling at least one graphics processing unit command which is produced by the application program; detecting a usage pattern of a central processing unit and a usage pattern of a graphics processing unit; classifying the application program into at least one application program phase according to the graphics processing unit command; determining a governing policy for a central processing unit governor and a governing policy for the graphics processing unit governor according to the application program phase; classifying a frequency-scaling intent of the central processing unit and a frequency-scaling intent of the graphics processing unit according to the usage pattern of the central processing unit and the usage pattern of the graphics processing unit; and determining a management policy of the central processing unit and a management policy of the graphics processing unit according to the governing policy and the frequency-scaling intent of the central processing unit and the governing policy and the frequency-scaling intent of the graphics processing unit.

### BRIEF DESCRIPTION OF THE DRAWINGS

FIG. 1 is a diagram showing one preferred embodiment of the electronic device of the present invention; and

FIG. 2 is a flowchart showing one preferential embodiment of the energy saving method of the present invention.

### DETAILED DESCRIPTION OF THE INVENTION

In order to describe details of the preferred embodiments of the present invention, description of the structure, and the application as well as the steps are made with reference to the accompanying drawings. It is learned that after the description, any variation, modification or the like to the structure and the steps of the embodiments of the preferred embodiments of the present invention is easily made available to any person skilled in the art. Thus, the following description is only for illustrative purpose only and does not, in any way, try to limit the scope of the present invention.

None of the previous work has considered the information gaps between a user, a CPU, and a GPU. In this section, the present invention discloses a user-centric CPU-GPU governing framework to bridge both the demand-level and processor-level gaps. To bridge the gap at the demand level, it is essential to identify the user demand at runtime and accordingly determine the appropriate governing policies for respective processors.

Correspondingly, to bridge the gap at the processor level, it is important to communicate the frequency-scaling intents of the processors. In this way, the governors can be prevented from scaling frequency while not improving the user experience. Note that the proposed governing framework is structured above the governor policies, thus existing governor policies can be integrated into the proposed framework when needed.

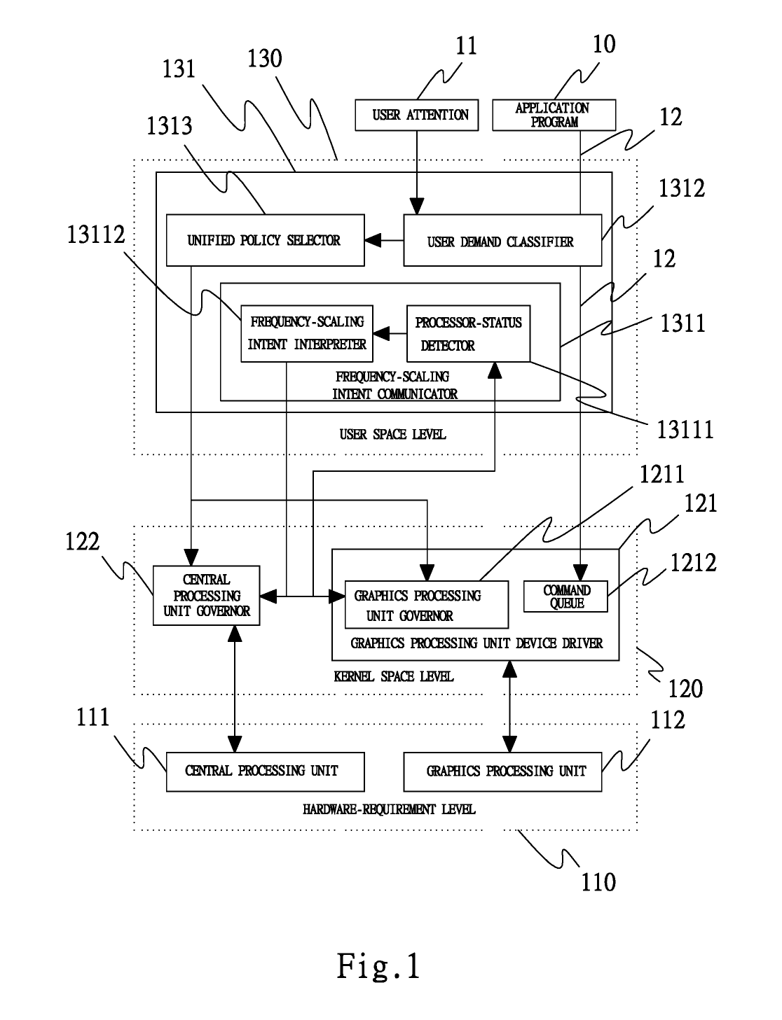

Refer to FIG. 1, which is a diagram showing one preferred embodiment of an electronic device of the present invention. As shown in FIG. 1, In the electronic device of the present invention for operating an application program 10, the application program 10 produces at least one graphics processing unit command 12, the electronic device comprises a central processing unit 111, a central processing unit governor 122, a graphics processing unit 112, a graphics processing unit governor 1211 and a governing framework 131. Wherein, the central processing unit governor 122 connects to the central processing unit 111 and allocates computing resource of the central processing unit 111 based on the operating frequency of the central processing unit 111, the number of active central processing unit cores, and a combination of the active central processing unit clusters. The graphics processing unit governor 1211 connects to the graphics processing unit 112 and allocates computing resource of the graphics processing unit 112 based on the operating frequency of the graphics processing unit 112 and a number of active graphics processing unit cores.

The governing framework 131 of the present invention comprises a user demand classifier 1312, a unified policy selector 1313 and a frequency-scaling intent communicator 1311.

The user demand classifier 1312 connects to the application program 10, and profiles at least one graphics processing unit command 12 that is produced by the application program 10 and classifies the application program 10 into at least one application program phase according to the graphics processing unit command 12.

The unified policy selector 1313 connects to the user demand classifier 1312, the central processing unit governor 122, and the graphics processing unit governor 1211, and determines a governing policy for the central processing unit governor 122 and a governing policy for the graphics processing unit governor 1211 according to the application program phase.

The frequency-scaling intent communicator 1311 comprises: a processor-status detector 13111 and a frequency-scaling intent interpreter 13112. Wherein, the processor-status detector 13111 connects to the central processing unit governor 122 and the graphics processing unit governor 1211, and detects a usage pattern of the central processing unit 111 and a usage pattern of the graphics processing unit 112. The frequency-scaling intent interpreter 13112 connects to the processor-status detector 13111, the central processing unit governor 122, and the graphics processing unit governor 1211, and classifies a frequency-scaling intent of the central processing unit 111 and a frequency-scaling intent of the graphics processing unit 112 according to the usage pattern of the central processing unit 111 and the usage pattern of the graphics processing unit 112.

The central processing unit governor 122 and the graphics processing unit governor 1211 determine a management policy of the central processing unit 111 and a management policy of the graphics processing unit 112 according to the governing policy and the frequency-scaling intent of the central processing unit 111 and the governing policy and the frequency-scaling intent of the graphics processing unit 112.

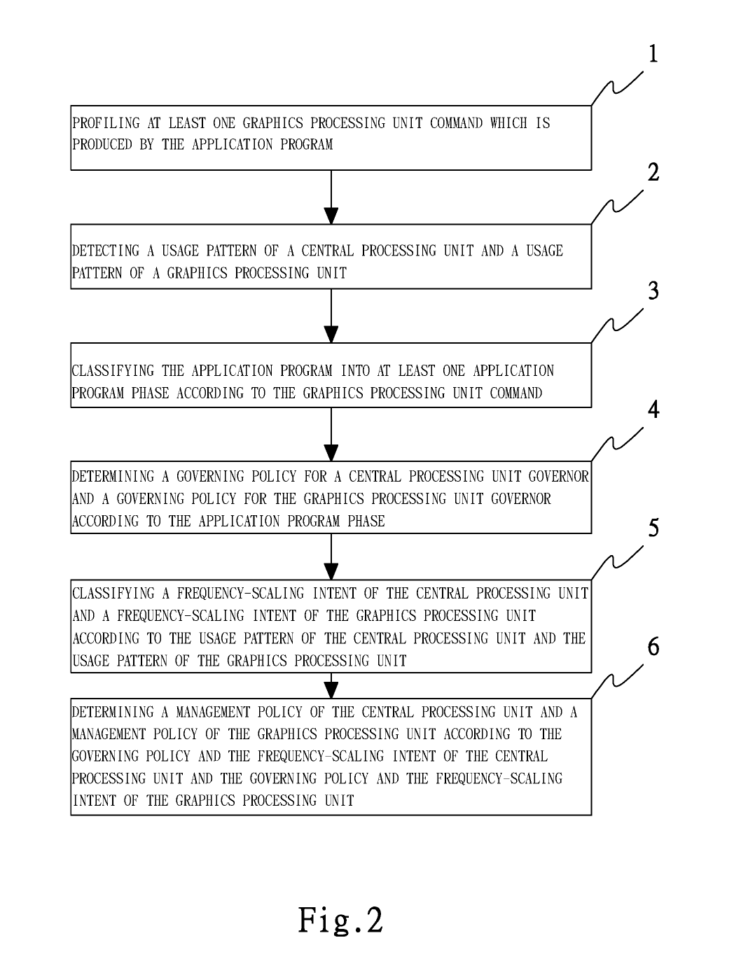

With reference to FIGS. 1 and 2, FIG. 2 is a flowchart showing one preferential embodiment of an energy saving method of the present invention. In the energy saving method of the present invention for operating an application program, the application program produces at least one graphics processing unit command, the energy saving method comprises the steps: (1) profiling at least one graphics processing unit command which is produced by the application program; (2) detecting a usage pattern of a central processing unit and a usage pattern of a graphics processing unit; (3) classifying the application program into at least one application program phase according to the graphics processing unit command; (4) determining a governing policy for a central processing unit governor and a governing policy for the graphics processing unit governor according to the application program phase; (5) classifying a frequency-scaling intent of the central processing unit and a frequency-scaling intent of the graphics processing unit according to the usage pattern of the central processing unit and the usage pattern of the graphics processing unit; and (6) determining a management policy of the central processing unit and a management policy of the graphics processing unit according to the governing policy and the frequency-scaling intent of the central processing unit and the governing policy and the frequency-scaling intent of the graphics processing unit.

The user demand classifier 1312 is activated periodically to monitor the application program 10 at runtime of, for example, a game application program. The unified policy selector 1313 configures the governing policy for the central processing unit governor 122 and the governing policy for the graphics processing unit governor 1211. In turn, the frequency-scaling intent communicator 1311 is activated only when the utilization threshold for scaling frequency is reached at either the central processing unit 111 or the graphics processing unit 112. To classify the user demand, the present invention differentiates the application phases based on a graphics processing unit command 12, and determines user attention 11 according to the occurrence of any touch event. After classifying user demand, the present invention then determines the governing policies and classifies the frequency-scaling intents of the central processing unit 111 and the graphics processing unit 112.

Details of the present invention are described in the following embodiments. The present invention discloses a way to bridge the communication channel of the central processing unit 111 and the graphics processing unit 112 in consideration of both the user experience and a system architecture of a device. The present invention is not limited by the implemented layer, relative orientation and architecture of the proposed components.

The architecture of current computing devices can be divided into three layers: a hardware-requirement level 110, a kernel space level 120, and a user space level 130. The hardware-requirement level 110 comprises the various hardware devices such as the central processing unit 111 and the graphics processing unit 112 which provide computing power to devices. Generally, the central processing unit 111 and the graphics processing unit 112 provide controlling interfaces to adjust the frequency, voltage and power-state. For example, a multi-core central processing unit 111 is equipped with the ability to adjust the operating frequency and the number of operating cores.

In typical operating systems like Linux, system memory and programs can be divided into two distinct parts: the user space level 130 and the kernel space level 120. The user space level 130 contains the governing framework 131 of the present invention and applications that provide services to users. While the kernel space level 120 comprises a central processing unit governor and a graphics processing unit device driver 121, which are designed to provide services to the user space level 130 and manage the available hardware in the hardware-requirement level 110. The graphics processing unit device driver 121 comprises a graphics processing unit governor 1211 and a command queue 1212. The command queue 1212 receives at least one graphics processing unit command 12.

For example, the central processing unit governor 122 periodically controls the resources of the central processing unit 111 based on a pre-designed policy which, for example, raises the frequency and turns on the core of the central processing unit 111 if the utilization of the central processing unit 111 is higher than a pre-defined threshold, or lowers the frequency and turns off the core of the central processing unit 111 if the utilization of the central processing unit 111 is lower than a pre-defined threshold.

The graphics processing unit device driver 121 not only manages resources of the graphics processing unit 112 but also dispatches the workload to the graphics processing unit 112. Similarly, the graphics processing unit governor 1211 in the graphics processing unit device driver 121 manages the resource allocation of the graphics processing unit 112 according to the usage such as utilization of the graphics processing unit 112. The graphics processing unit device driver 121 contains a command queue 1212 which buffers the workload of the graphics processing unit 112 that applications invoke and can be processed by the graphics processing unit device driver 121. Once the command queue 1212 contains unread commands, the graphics processing unit device driver 121 fetches and processes the graphics processing unit command 12.

To bridge the processor-level gap, the governing framework 131 is established in the present invention. The frequency-scaling intent communicator comprises the processor-status detector 13111 and the frequency-scaling intent interpreter 13112. The frequency-scaling intent interpreter 13112 communicates with the central processing unit governor 122 and the graphics processing unit governor 1211 to finalize the decisions of governing the central processing unit 111 and the graphics processing unit 112 based on the received frequency-scaling intents from the frequency-scaling intent interpreter 13112. Governing decisions of the central processing unit governor 122 (responds to the graphics processing unit governor 1211) will be invalid if the decisions violate the frequency-scaling intent of the central processing unit governor 122 (responds to the graphics processing unit governor 1211). For example, if the frequency-scaling intent interpreter 13112 of the governing framework 131 decides to scale up (responds down) the frequency of the central processing unit 111 while the frequency-scaling intent of the central processing unit governor 122 is “slowdown” (responds to “speedup”), the decision will be discarded.

To monitor the status of the central processing unit 111 and the graphics processing unit 112, the processor-status detector 13111 detects the usage of the central processing unit 111 and the graphics processing unit 112. Through accessing the related interface of the central processing unit 111 and the graphics processing unit 112 drivers, the processor-status detector 13111 can detect variables of the central processing unit 111 and the graphics processing unit 112, such as utilization, number of active cores, current frequency level and usage of the graphics processing unit command 12, in the kernel space every sample period. After each detection of the processor-status detector 13111, the processor-status detector 13111 passes these variables to the frequency-scaling intent interpreter 13112.

In the present invention, the frequency-scaling intent interpreter 13112 interprets the frequency-scaling intent of the central processing unit 111 and the graphics processing unit 112 based on the collected information and CPU-GPU interacting model of devices. In an embodiment, the present invention classifies the intent of the frequency-scaling intent interpreter 13112 as “speedup”, “slowdown” and “self-rule”. However, the types and number of classified intents is not limited in the present invention. In this embodiment, a “slowdown” intent is interpreted for a governor if the computing utilization of the processor won't increase. For example, if the central processing unit 111 produces the workload of the graphics processing unit 112, and the central processing unit 111 is overloading through the processors' information of the processor-status detector 13111, the frequency-scaling intent interpreter 13112 knows the workload of the graphics processing unit 112 won't increase because the central processing unit 111 is too busy to generate the following workload. Thus, the frequency-scaling intent of the graphics processing unit governor 1211 is “slowdown”.

A “speedup” intent is interpreted for a governor if the workload of the central processing unit 111 and the graphics processing unit 112 is needed to increase. For example, if the running application program 10 needs the computing power of the central processing unit 111, and the central processing unit 111 is not overloading, the frequency-scaling intent interpreter 13112 interpret the frequency-scaling intent of the central processing unit governor 122 as “speedup” intent in order to enhance the user experience of the device. A “self-rule” intent is interpreted for the central processing unit governor 122 and the graphics processing unit governor 1211 if there is not a specific demand of the central processing unit 111 and the graphics processing unit 112, and the central processing unit governor 122 and the graphics processing unit governor 1211 can govern by their default policy when the “self-rule” intent is received.

In an embodiment, the governing framework 131 periodically executes the processor-status detector 13111 and the frequency-scaling intent interpreter 13112 in order to build a communication channel of the central processing unit governor 122 and the graphics processing unit governor 1211 when the user plays a graphic-intensive application. For example, when the user is playing a 3D mobile game, the processor-status detector 13111 detects the usage of the central processing unit 111 and the graphics processing unit 112 at runtime. The status of the central processing unit 111 and the graphics processing unit 112 is passed to the frequency-scaling intent interpreter 13112 in order to interpret the frequency-scaling intents.

Taking both the interacting model of the central processing unit governor 122 and the graphics processing unit governor 1211 and the status of the central processing unit 111 and the graphics processing unit 112 into consideration, the frequency-scaling intent interpreter 13112 realizes the following workload trend of the central processing unit 111 and the graphics processing unit 112. Then, the frequency-scaling intent interpreter 13112 interprets the frequency-scaling intents based on predefined rules. Once the central processing unit governor 122 and the graphics processing unit governor 1211 make decisions based on governing policies, the frequency-scaling intent interpreter 13112 finalizes the governing decision of the central processing unit governor 122 and the graphics processing unit governor 1211 before the decisions take place. If the decision contradicts the intents, the decision will be discarded or modified. Through the above procedure, the present invention discloses an interactive channel between the central processing unit 111 and the graphics processing unit 112, and thus improves the user experience or reduces energy consumption when the user uses graphic-intensive application programs 10.

On the other hand, to bridge the demand-level gap, the governing framework 131 classifies the user's demand at runtime. The user demand classifier 1312 identifies the application phase of the gaming application program 10 that is being executed and the user attention level through monitoring the stream of the graphics processing unit command 12 and touching activities of a user separately. Different types of graphics processing unit commands 12 put different burdens on the central processing unit 111 and the graphics processing unit 112 and affect the user experience differently. Thus, the user demand classifier 1312 identifies the application phase through profiling the usage of the graphics processing unit command 12.

If the graphics processing unit commands 12 that are sent from the gaming application program 10 to the command queue 1212 require a lot of computing power of the central processing unit 111 or the graphics processing unit 112, the user demand classifier 1312 identifies the user's demand of the hardware-requirement level of the central processing unit 111 and the graphics processing unit 112. For example, based on the impact of sending the graphics processing unit command 12 to a user, the user demand classifier 1312 classifies the main performance index of the current gaming application program 10, that is, frame rate or response time.

Moreover, the user demand classifier 1312 monitors the user attention 11 level through profiling interacting behaviors of the device, and a higher user attention 11 level means that the user needs better performance for the gaming application program 10. For example, when a user is interacting with a gaming application program 10, the user expects better performance during interaction.

The user demand classifier 1312 identifies the application phase of the gaming application program 10 that is being executed and the user attention 11 level through monitoring the stream of the graphics processing unit command 12 and touching activities of a user separately. For classifying application program 10 phases, the observation derived from profiling the graphics processing unit command 12 is provided, and accordingly discrimination between GPU-sensitive phase, e.g. the rendering phase, and GPU-insensitive phase, e.g. the loading phase is made. On the other hand, when a user is interacting with an application program 10, the performance requirement is elevated in order to be responsive to the input events. Furthermore, in the last period of the application program 10, if the graphics processing unit command 12 emphasizing the central processing unit 111 computing or no command at all are observed, the application program phase is determined to be the graphics processing unit insensitive phase. In the last period of the application program 10, if the application program phase is not the graphics processing unit insensitive phase, the application program phase is determined to the graphics processing unit sensitive phase.

Therefore, the governing framework 131 classifies user attention 11 into an interacting state and a non-interacting state by investigating whether there is any touch event on screen.

Furthermore, if there is any touch event, the state of user attention 11 is determined to be the interacting phase. If it is not an interacting phase, the state of user attention 11 is determined to be the non-interacting phase. The central processing unit governor 122 and the graphics processing unit governor 1211 determine the management policy of the central processing unit 111 and the management policy of the graphics processing unit 112 according to the user attention 11, the governing policy, and the frequency-scaling intent of the central processing unit 111, and the user attention 11, the governing policy, and the frequency-scaling intent of the graphics processing unit 112.

After the identification of the user demand classifier 1312, the unified policy selector 1313 selects governing policies of the central processing unit governor 122 and the graphics processing unit governor 1211 based on the user's demand. For example, if the user demand classifier 1312 identifies that the user requires more resources of the central processing unit 111 at the current application phase, the unified policy selector 1313 selects a performance-favor policy for the central processing unit governor 122. For example, if the user demand classifier 1312 performance index of the current application phase is not mainly affected by the graphics processing unit 112, the unified policy selector 1313 selects an energy-efficient favor governing policy for the graphics processing unit governor 1211.

By combining the phases of the game application program 10 and the states of the user, four distinct classes for classifying the user's demand are obtained. The responsibility of the unified policy selector 1313 is to select the policy for different phases and user interactions. When the application program 10 is in the GPU-insensitive phase and the user is not interacting with the application program 10, the central processing unit governor 122 is configured to the On-demand policy and the graphics processing unit governor 1211 is configured to the Conservative policy.

On the other hand, when the application program 10 is in the GPU-insensitive phase and the user is interacting with the application, the central processing unit governor 122 is configured to the Performance policy and the graphics processing unit governor 1211 is configured to the On-demand policy. The reasoning is that the events caused by the interaction should be processed as soon as possible in the central processing unit 111 so that the best possible user experience is provided. In addition, in case the application phase switches to GPU-sensitive after user interaction, the governing policy on the graphics processing unit 112 should be configured with increasing performance favor.

Likewise, when the application program 10 is in the GPU-sensitive phase and the user is not interacting with the application program 10, both the central processing unit governor 122 and the graphics processing unit governor 1211 are configured to the Conservative policy. On the other hand, when the application program 10 is in the GPU-sensitive phase and the user is interacting with the application program 10, the central processing unit governor 122 is configured to the On-demand policy and the graphics processing unit governor 1211 is configured to the Conservative policy. The reasoning is again that the central processing unit 111 needs to briefly react to interacting events.

In an embodiment, the governing framework 131 periodically executes the user demand classifier 1312 and the unified policy selector 1313 in order to match the governing policies of the central processing unit 111 and the graphics processing unit 112 to meet a user's expectation. For example, when the user is playing a 3D game which is interacted with during a rendering scene, the user demand classifier 1312 identifies that the current application phase of this game requires more computing resource of the graphics processing unit 112 based on the usage of the graphics processing unit command 12.

The user demand classifier 1312 also examines current user behavior and whether the user is currently interacting with the device. Then, taking the application phase and user behavior into consideration, the user demand classifier 1312 sends the current user demand to the unified policy selector 1313. When the unified policy selector 1313 receives the user's demand for rendering scenes, the unified policy selector 1313 select a governing policy that is suitable for the characteristic of rendering scenes for the graphics processing unit governor 1211 in order to achieve a better user experience, for example, a smooth frame rate.

On the other hand, the unified policy selector 1313 sets the policy of the central processing unit governor 122 as an energy-efficient favoring one in order to save unnecessary energy usage because the user experience is mainly dominated by the decision of the graphics processing unit governor 1211, and the user experience won't be improved if the central processing unit governor 122 allocates more computing resources of the central processing unit 111.

While the invention has been described in connection with what is considered the most practical and preferred embodiments, it is understood that this invention is not limited to the disclosed embodiment but is intended to cover various arrangements included within the spirit and scope of the broadest interpretation so as to encompass all such modifications and equivalent arrangements.

What is claimed is:

1. An electronic device for operating an application program, the application program producing at least one graphics processing unit command, the electronic device comprising:
a central processing unit;
a central processing unit governor connecting to the central processing unit;
a graphics processing unit;
a graphics processing unit governor connecting to the graphics processing unit; and
a governing framework comprising:
a user demand classifier connecting to the application program, the user demand classifier profiling at least one graphics processing unit command that is produced by the application program and classifying the application program into at least one application program phase according to the graphics processing unit command;
a unified policy selector connecting to the user demand classifier, the central processing unit governor, and the graphics processing unit governor, the unified policy selector determining a governing policy for the central processing unit governor and a governing policy for the graphics processing unit governor according to the application program phase; and
a frequency-scaling intent communicator comprising:
a processor-status detector connecting to the central processing unit governor and the graphics processing unit governor, the processor-status detector detecting a usage pattern of the central processing unit and a usage pattern of the graphics processing unit; and
a frequency-scaling intent interpreter connecting to the processor-status detector, the central processing unit governor, and the graphics processing unit governor, the frequency-scaling intent interpreter classifying a frequency-scaling intent of the central processing unit and a frequency-scaling intent of the graphics processing unit according to the usage pattern of the central processing unit and the usage pattern of the graphics processing unit;
wherein the central processing unit governor and the graphics processing unit governor determine a management policy of the central processing unit and a management policy of the graphics processing unit according to the governing policy and the frequency-scaling intent of the central processing unit and the governing policy and the frequency-scaling intent of the graphics processing unit.

2. The electronic device as claimed in claim 1, further comprising a command queue, the command queue receiving at least one graphics processing unit command.

3. The electronic device as claimed in claim 1, wherein the central processing unit governor allocates computing resources of the central processing unit based on operating frequency of the central processing unit, number of active central processing unit cores, and a combination of active central processing unit clusters.

4. The electronic device as claimed in claim 1, wherein the graphics processing unit governor allocates computing resources of the graphics processing unit based on operating frequency of the graphics processing unit and number of active graphics processing unit cores.

5. The electronic device as claimed in claim 1, wherein the frequency-scaling intent comprises speedup, slowdown, and self-rule, and the application program phase comprises a graphics processing unit sensitive phase and a graphics processing unit insensitive phase.

6. The electronic device as claimed in claim 5, wherein in a last period of the application program, if the graphics processing unit command emphasizes central processing unit computing or no command at all are observed, the application program phase is determined to be the graphics processing unit insensitive phase; and in the last period of the application program, if the application program phase is not the graphics processing unit insensitive phase, the application program phase is determined to be the graphics processing unit sensitive phase.

7. The electronic device as claimed in claim 1, further comprising if there is any touch event, a state of user attention is determined to be the interacting phase, if it is not an interacting phase, the state of user attention is determined to be the non-interacting phase, and the central processing unit governor and the graphics processing unit governor determine the management policy of the central processing unit and the management policy of the graphics processing unit according to the user attention, the governing policy, and the frequency-scaling intent of the central processing unit and the user attention, the governing policy, and the frequency-scaling intent of the graphics processing unit.

8. An energy saving method for operating an application program, the application program producing at least one graphics processing unit command, the energy saving method comprises steps:
profiling at least one graphics processing unit command which is produced by the application program;
detecting a usage pattern of a central processing unit and a usage pattern of a graphics processing unit;
classifying the application program into at least one application program phase according to the graphics processing unit command;
determining a governing policy for a central processing unit governor and a governing policy for the graphics processing unit governor according to the application program phase;
classifying a frequency-scaling intent of the central processing unit and a frequency-scaling intent of the graphics processing unit according to the usage pattern of the central processing unit and the usage pattern of the graphics processing unit; and
determining a management policy of the central processing unit and a management policy of the graphics processing unit according to the governing policy and the frequency-scaling intent of the central processing unit and the governing policy and the frequency-scaling intent of the graphics processing unit.

9. The energy saving method as claimed in claim 8, wherein the frequency-scaling intent comprises speedup, slowdown, and self-rule, and the application program phase comprises a graphics processing unit sensitive phase and a graphics processing unit insensitive phase.

10. The energy saving method as claimed in claim 9, wherein in a last period of the application program, if the graphics processing unit command emphasizes central processing unit computing or no command at all are observed, the application program phase is determined to be the graphics processing unit insensitive phase; and in the last period of the application program, if the application program phase is not the graphics processing unit insensitive phase, the application program phase is determined to be the graphics processing unit sensitive phase.

11. The energy saving method as claimed in claim 8, further comprising if there is any touch event, a state of user attention is determined to be the interacting phase, if it is not an interacting phase, the state of user attention is determined to be the non-interacting phase, and the management policy of the central processing unit and the management policy of the graphics processing unit are determined according to user attention, the governing policy, and the frequency-scaling intent of the central processing unit and the user attention, the governing policy, and the frequency-scaling intent of the graphics processing unit.
